(19) United States
(12) Patent Application Publication
(10) Pub. No.: US 2024/0312700 A1
(43) Pub. Date: Sep. 19, 2024

(54) COIL COMPONENT

(71) Applicant: TDK Corporation, Tokyo (JP)

(72) Inventors: Yuichi OYANAGI, Tokyo (JP); Toru TONOGAI, Tokyo (JP); Tomoya ISHIHARA, Tokyo (JP)

(73) Assignee: TDK Corporation, Tokyo (JP)

(21) Appl. No.: 18/597,162

(22) Filed: Mar. 6, 2024

(30) Foreign Application Priority Data
Mar. 15, 2023 (JP) 2023-040652

(51) Int. Cl. H01F 27/34; H01F 27/02; H01F 27/28

(52) U.S. Cl. CPC H01F 27/346; H01F 17/04; H01F 27/2823; H01F 2017/048

(57) ABSTRACT

In a coil component, a magnetic sheet is inclined in the area overlapping with a coil in the vertical direction, and the magnetic sheet is along the orientation of the magnetic flux in the vicinity of the inner edge of the coil. Therefore, magnetic flux easily passes through the magnetic sheet, and reduction of leakage flux in the coil component is realized.

### CROSS-REFERENCE TO RELATED APPLICATIONS

This application is based upon and claims the benefit of priority from Japanese Patent Application No. 2023-40652, filed on 15 Mar. 2023, the entire content of which is incorporated herein by reference.

### TECHNICAL FIELD

The present disclosure relates to a coil component.

### BACKGROUND

Japanese Patent Application Publication No. 2003-203813 discloses a coil component including an insulating element body having a coil and a sheet-like magnetic body disposed on the element body.

### SUMMARY

The inventors have studied the leakage flux of the coil component that causes noise, and have found that the leakage flux can be reduced by providing a magnetic sheet inside a magnetic element body including the coil. In particular, it has been found that the leakage flux can be further reduced by providing the magnetic sheet in a posture corresponding to the shape of the coil.

According to various aspects of the present disclosure, there is provided a coil component with reduced leakage flux.

A coil component according to one aspect of the present disclosure includes an element body made of material including metal powder and resin, a coil provided in the element body; and a magnetic sheet extending to intersect an axis of the coil in the element body, wherein the magnetic sheet has a portion corresponding to a tip position of the coil with respect to a direction of an axis of the coil, and the portion is inclined toward the coil side as the portion approaches the axis of the coil.

In the coil component, the magnetic flux in the vicinity of the inner edge of the coil passes through the portion of the magnetic sheet inclined toward the coil side as approaching the axis of the coil, thereby reducing the leakage magnetic flux.

A coil component according to other aspect of the present disclosure includes an element body made of material including metal powder and resin, a coil provided in the element body, and a magnetic sheet extending to intersect an axis of the coil in the element body, wherein the magnetic sheet has a portion corresponding to a tip position of the coil with respect to a direction of the axis of the coil, and the portion is inclined toward the coil side as the portion separates from the axis of the coil.

In the coil component, the magnetic flux in the vicinity of the outer edge of the coil passes through the portion of the magnetic sheet inclined toward the coil side as separating the axis of the coil, thereby reducing the leakage magnetic flux.

A coil component according to other aspect of the present disclosure includes an element body made of material including metal powder and resin, a coil provided in the element body, and a magnetic sheet extending to intersect an axis of the coil in the element body, wherein the magnetic sheet has a portion corresponding to a tip position of the coil with respect to a direction of the axis of the coil and a portion corresponding to the axis of the coil, the positions of the magnetic sheet with respect to the direction of the axis of the coil are different therebetween.

In the coil component, the positions of the magnetic sheet with respect to the direction of the axis of the coil are not uniform, the magnetic sheet is not a flat sheet. In this case, since the portion corresponding to the tip position of the coil of the magnetic sheet at least partially follows the shape of the coil, the magnetic flux of the coil to pass easily, and the leakage flux is reduced.

### BRIEF DESCRIPTION OF THE DRAWINGS

FIG. 1 shows a schematic perspective view of a coil component according to a first embodiment.

FIG. 2 shows a cross-sectional view taken along line II-II of the coil component shown in FIG. 1.

FIG. 3 shows a schematic perspective view of the coil shown in FIG. 2.

FIG. 4 shows an enlarged cross-sectional view of the configuration of the element body.

FIG. 5 shows a diagram of a positional relationship between the magnetic sheet and the coil.

FIG. 6 shows a cross-sectional view of a coil component different from that of FIG. 2.

FIG. 7 shows a cross-sectional view of a coil component according to a second embodiment.

FIG. 8 shows a diagram of a positional relationship between the magnetic sheet and the coil.

FIG. 9 shows a cross-sectional view of coil component different from that of FIG. 2.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

### First Embodiment

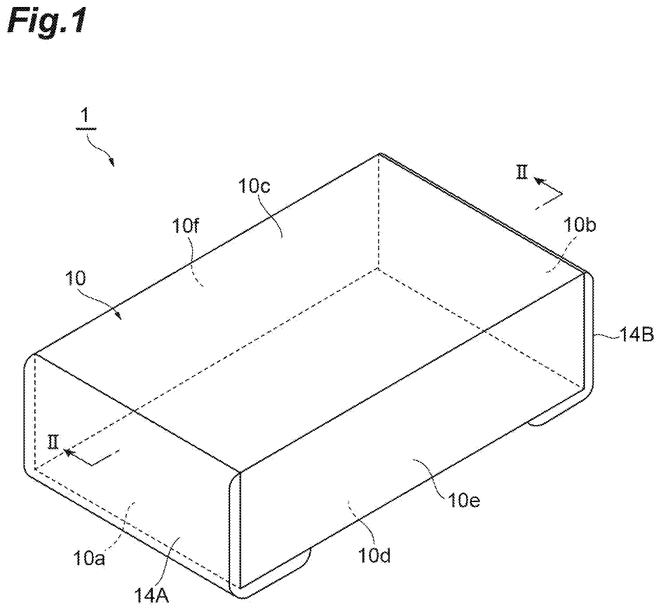

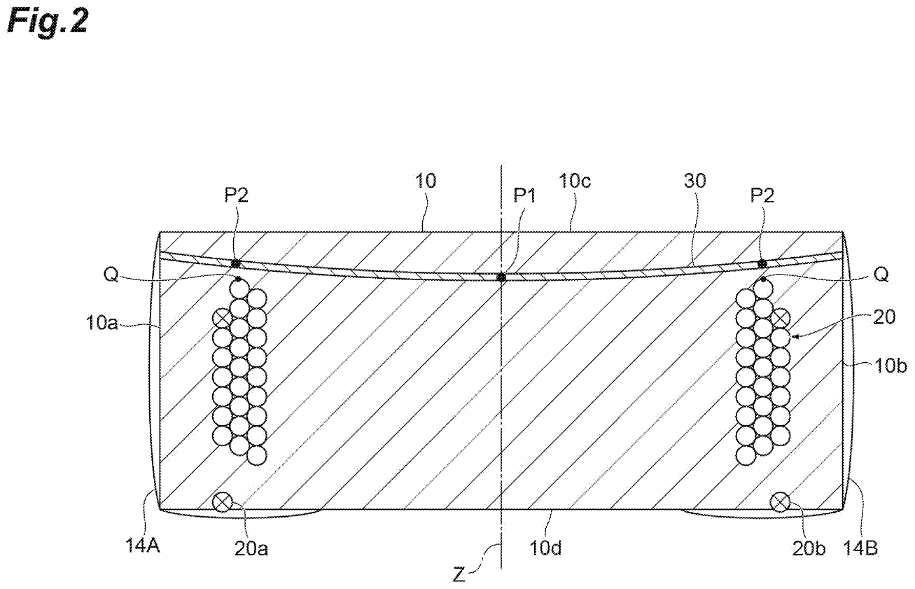

As shown in FIGS. 1 and 2, a coil component 1 according to a first embodiment includes an element body 10, a coil 20 embedded in the element body 10, and a pair of external terminals 14A and 14B provided on the surface of the element body 10.

The element body 10 has a substantially rectangular parallelepiped outer shape and includes six surfaces 10a to 10f. The element body 10, as an example, is designed with dimensions of a longer side 2.5 mm, a shorter side 2.0 mm, height 1.2 mm. Of the surfaces 10a to 10f of the element body 10, end surfaces 10a and 10b are parallel to each other, an upper surface 10c and a lower surface 10d are parallel to each other, and side surfaces 10e and 10f are parallel to each other. The lower surface 10d of the element body 10 is the surface parallel and facing to the mounting surface of the mounting substrate on which the coil component 1 is mounted.

The element body 10 is made of metal magnetic powder-containing resin, which is one kind of magnetic material. The metal magnetic powder-containing resin is a bound powder in which metal magnetic powder is bound by binder resin. The metal magnetic powder of the metal magnetic powder-containing resin contains, for example, iron, and is composed of alloy-based material such as permalloy, sendust, FeSiCr, FeSi, carbonyl iron, amorphous alloy, nanocrystal, or the like. The metal magnetic powder may be selected from materials having hardness higher than that of the magnetic sheet 30, which will be described later. The binder resin is, for example, a thermosetting epoxy resin. In the present embodiment, the content of the metal magnetic powder in the bound powder is 75 to 92 vol % in volume percent, and 95 to 99 wt % in weight percent. From the viewpoint of the magnetic property, the content of the metal magnetic powder in the bound powder may be 80 to 92 vol % in volume percent and 97 to 99 wt % in weight percent.

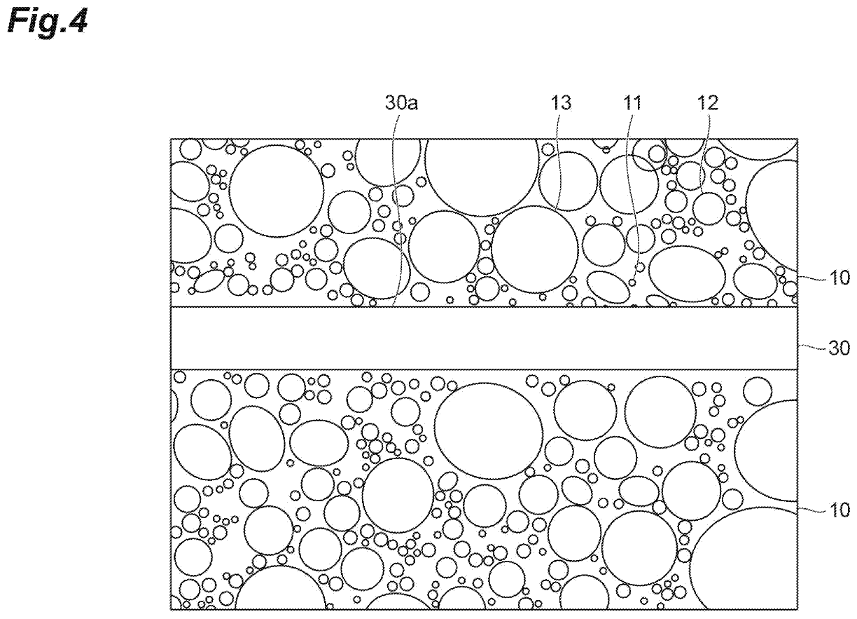

The magnetic powder of the metal magnetic powder-containing resin constituting the element body 10 may be a powder having one kind of average particle diameter or a mixed powder having a plurality of kinds of average particle diameters. When the magnetic powder of the metal magnetic powder-containing resin constituting the element body 10 is a mixed powder, the types of magnetic powders having different average particle diameters and the Fe composition rate may be the same or different. In the present embodiment, the metal magnetic powder-containing resin constituting the element body 10 includes mixed powder having three types of average particle diameters. As an example, particles having the maximum average particle diameter (maximum diameter powder 14 in FIG. 4) have 15 to 30 μm diameter, particles having the minimum average particle diameter (minimum diameter powder 11 in FIG. 4) have 0.3 to 1.5 μm diameter, and particles having diameters between the maximum and the minimum diameters (medium diameter powder 12 in FIG. 4) have 3 to 10 μm diameter. Relative to 100 parts by weight of the mixed powder, the maximum diameter powder 14 may be contained in a range of 60 to 80 parts by weight, the medium diameter powder 12 may be contained in a range of 10 to 20 parts by weight, and the minimum diameter powder 11 may be contained in a range of 10 to 20 parts by weight.

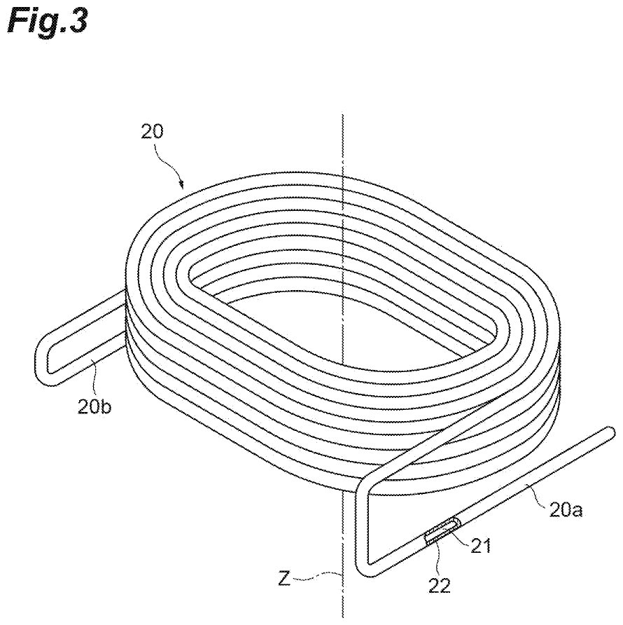

The coil 20 is embedded in the element body 10. As shown in FIG. 3, the coil 20 is formed of a wire-like coated conductive wire. The wire may be obtained by coating a core material 21 made of Cu or the like with an insulating coating 22 (insulator). The coil 20 has an axis Z extending in the vertical direction (i.e., the facing direction of the upper surface 10c and the lower surface 10d). The axis Z is positioned at the center of the coil 20 when viewed from the vertical direction. In the present embodiment, one coil conductor is spirally wound in multiple layers along the vertical direction. One end portion 20a and the other end portion 20b of the coil 20 are exposed to the lower surface 10d in the element body 10. In the present embodiment, the end portions 20a and 20b of the coil 20 extend in a direction parallel to the end surfaces 10a and 10b in the lower surface 10d in the element body 10. In both of the end portions 20a and 20b of the coil 20, the insulating coating 22 is removed by polishing or the like, and the core material 21 is exposed at the lower surface 10d. The end portions 20a and 20b of the coil 20 are connected to portions covering the lower surface 10d of the element body 10 of the external terminals 14A and 14B, respectively. The coil 20 may be a round wire having a circular cross-sectional surface or a rectangular wire having a quadrangular cross-sectional surface.

Both the external terminals 14A and 14B are bent in an L-shape and continuously cover the end surfaces 10a and 10b and the lower surface 10d. The external terminal 14A covers entire the end surface 10a and a partial region of the lower surface 10d (in particular, a rectangular region extending along the edge on the end surface 10a side). The external terminal 14B covers entire the end surface 10b and a partial region of the lower surface 10d (in particular, a rectangular region extending along the edge on the end surface 10b side). Portions covering the lower surface 10d of the external terminals 14A and 14B cover the end portions 20a and 20b of the coil 20 exposed to the lower surface 10d.

In the present embodiment, the external terminals 14A and 14B are formed of resin electrodes, for example, Ag powder-containing resin. The external terminals 14A and 14B can be formed by metal plating. The external terminals 14A and 14B may have a single-layer structure or a multilayer structure. The external terminals 14A and 14B may directly cover the surface of the element body 10, or may indirectly cover the surface of the element body 10 through a predetermined insulation layer. For example, the insulation layer may be provided over the entire formation region of the external terminals 14A and 14B excluding the connection region between the end portions 20a and 20b of the coil 20 and the external terminals 14A and 14B. The insulation layer may be made of epoxy resin or the like.

The magnetic sheet 30 is further provided inside the element body 10. The magnetic sheet 30 extends to intersect the axis Z of the coil 20. The magnetic sheet 30 extends over the entire region of the element body 10 when viewed from the direction of the axis Z of the coil 20. That is, when viewed from the direction of the axis Z of the coil 20, the element body 10 has a rectangular shape, and the magnetic sheet 30 also has a rectangular shape having substantially the same dimensions as the element body 10. The magnetic sheet 30 is exposed from both of the end surfaces 10a and 10b of the element body 10. The magnetic sheet 30 may be exposed from both of the side surfaces 10e and 10f of the element body 10. The magnetic sheet 30 may be in the form of a complete sheet or a locally divided sheet as long as it covers the entire region of the element body 10 when viewed from the direction of the axis Z of the coil 20.

In the present embodiment, the magnetic sheet 30 is located above the coil 20. That is, the magnetic sheet 30 is located between the coil 20 and the upper surface 10c of the element body 10 with respect to the vertical direction of the element body 10 (i.e., the direction of the axis Z of the coil 20). In the present embodiment, the magnetic sheet 30 is not exposed from the upper surface 10c of the element body 10 and is not in contact with the coil 20.

The magnetic sheet 30 may be formed of metal plate (or metal ribbon). The magnetic sheet 30 may be formed of amorphous ribbon or nanocrystalline ribbon. The magnetic sheet 30 may be made of composite material including metal magnetic powder and resin. The magnetic sheet 30 may be a single-layer structure made of one kind of material or a multilayer structure composed of one kind or multiple kinds of materials. When the magnetic sheet 30 has a multilayer structure, the magnetic sheet 30 may include a layer made of non-magnetic material (for example, a resin layer) in addition to a layer made of magnetic material (magnetic layer).

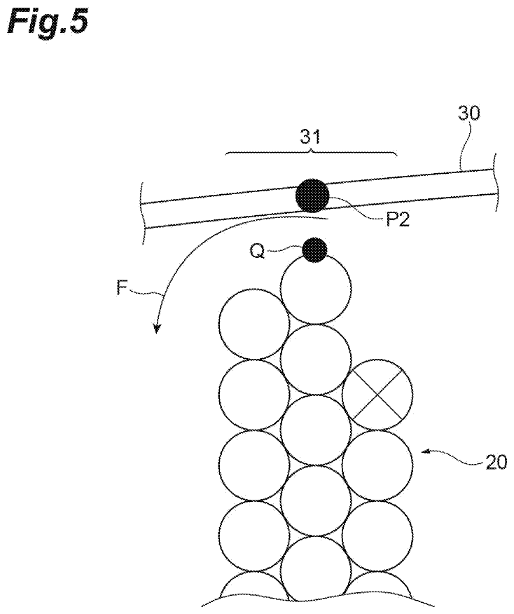

As shown in FIG. 2, the magnetic sheet 30 is generally bent to be convex toward the lower surface 10d side of the element body 10. In particular, the magnetic sheet 30 is generally curved with respect to the direction of the axis Z of the coil 20 such that a position P1 corresponding to the axis Z of the coil 20 is in the lowest position and progressively higher away from the position P1 corresponding to the axis Z of the coil 20. In the present embodiment, the magnetic sheet 30 has a line-symmetric cross-sectional shape with respect to the axis Z of the coil 20 in the cross-section shown in FIG. 2. The magnetic sheet 30 is uniformly inclined in an area 31 overlapping with the coil 20 in the vertical direction as shown in FIG. 5. That is, the magnetic sheet 30 is inclined such that the inner edge side of the coil 20 is lower and the outer edge side is higher. In particular, the magnetic sheet 30 is inclined such that portions of both a position P2 corresponding a tip position Q on the end surface 10a side of the coil 20 and a position P2 corresponding a tip position Q on the end surface 10b side of the coil 20 with respect to the direction of the axis Z of the coil 20 approach the lower side (i.e., the coil 20 side) as the portions approaches the axis Z of the coil 20. With respect to the direction of the axis Z of the coil 20, each of the positions P2 of the magnetic sheet 30 corresponding to the tip positions Q of the coil 20 on the end surface s10a and 10b side is positioned on the upper side (i.e., on the upper surface 10c side of the element body 10) with respect to the position P1.

The magnetic sheet 30 may have a cross-sectional shape that is not line-symmetric with respect to the axis Z of the coil 20 (i.e., asymmetric cross-sectional shape). In this case, the lowermost position of the magnetic sheet 30 may shift away from the position P1 corresponding to the axis Z of the coil 20 in the cross-section shown in FIG. 2. In the cross section shown in FIG. 2, the magnetic sheet 30 may have different positions in the vertical direction (i.e., different height positions) between the positions P2 corresponding to the tip positions Q of the coil 20 on the end surfaces 10a and 10b side, and may have different inclinations in the area 31 overlapping the coil 20 in the vertical direction.

In the coil component 1 according to the first embodiment, the magnetic sheet 30 is inclined in the area 31 overlapping with the coil 20 in the vertical direction, and the magnetic sheet 30 is along the orientation of magnetic flux F in the vicinity of the inner edge of the coil 20 as shown in FIG. 5. Therefore, the magnetic flux F easily passes through the magnetic sheet 30, and reduction of leakage flux in the coil component 1 is realized.

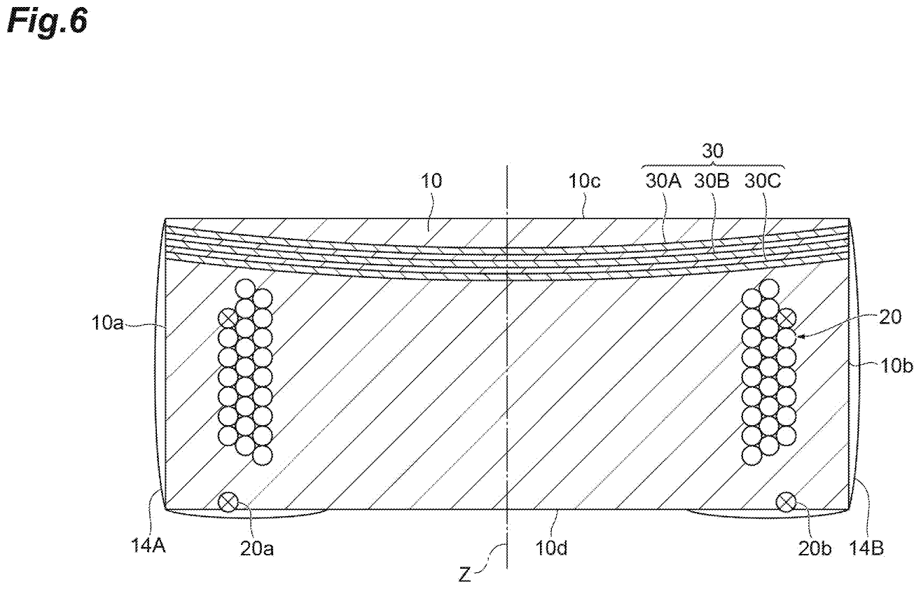

Only one magnetic sheet 30 may be provided in the element body 10, or a plurality of the magnetic sheets 30 may be provided in the element body 10. FIG. 6 shows an embodiment in which three magnetic sheets 30 (magnetic sheets 30A, 30B, and 30C) are provided. The three magnetic sheets 30A, 30B and 30C extend to intersect the axis Z of the coil 20. The magnetic sheets 30A, 30B, and 30C extend over the entire region of the element body 10 when viewed from the direction of the axis Z of the coil 20. Each of the magnetic sheets 30A, 30B, and 30C is exposed from the both end surfaces 10a and 10b of the element body 10. Each of the magnetic sheets 30A, 30B and 30C may be exposed from the both side surfaces 10e and 10f of the element body 10. All or part of the magnetic sheets 30A, 30B, and 30C may be in the form of a complete sheet or a locally divided sheet as long as it extends over the entire region of the element body 10 when viewed from the direction of the axis Z of the coil 20.

All of the magnetic sheets 30A, 30B, and 30C are located on the upper side of the coil 20. That is, all of the magnetic sheets 30A, 30B, and 30C are located between the coil 20 and the upper surface 10c of the element body 10 in the vertical direction of the element body 10. In the present embodiment, none of the magnetic sheets 30A, 30B, and 30C are exposed from the upper surface 10c of the element body 10 and none of the magnetic sheets 30A, 30B, and 30C are in contact with the coil 20.

The metal magnetic powder-containing resin constituting the element body 10 is interposed between the layers of the magnetic sheets 30A, 30B, and 30C. The interlayer distance of the magnetic sheets 30A, 30B, and 30C may be equal or different.

The magnetic sheets 30A, 30B, and 30C may be a single-layer structure constituted by one kind of material, or may be a multilayer structure constituted by one kind material or a plurality of kinds of materials, similarly to the magnetic sheet 30 described above. When the magnetic sheets 30A, 30B, and 30C have a multilayer structure, the magnetic sheets 30A, 30B, and 30C may include a layer made of non-magnetic material (for example, a resin layer) in addition to a layer made of magnetic material (magnetic layer).

### Second Embodiment

A coil component 1 according to a second embodiment is different from the coil component 1 according to the first embodiment in the shape of the magnetic sheet 30, and other elements are identical or similar to those of the first embodiment.

Similar to the magnetic sheet 30 according to the first embodiment, the magnetic sheet 30 according to the second embodiment extends to intersect the axis Z of the coil 20. The axis Z is positioned at the center of the coil 20 when viewed from the vertical direction. In the present embodiment, the magnetic sheet 30 extends entire the element body 10 when viewed from the direction of the axis Z of the coil 20. That is, when viewed from the direction of the axis Z of the coil 20, the element body 10 has a rectangular shape, and the magnetic sheet 30 has a rectangular shape having substantially the same dimensions as the element body 10. The magnetic sheet 30 is also exposed from both of the end surfaces 10a and 10b of the element body 10. The magnetic sheet 30 may be exposed from both of the side surfaces 10e and 10f of the element body 10. The magnetic sheet 30 may be in the form of a complete sheet or a locally divided sheet as long as it covers the entire region of the element body 10 when viewed from the direction of the axis Z of the coil 20.

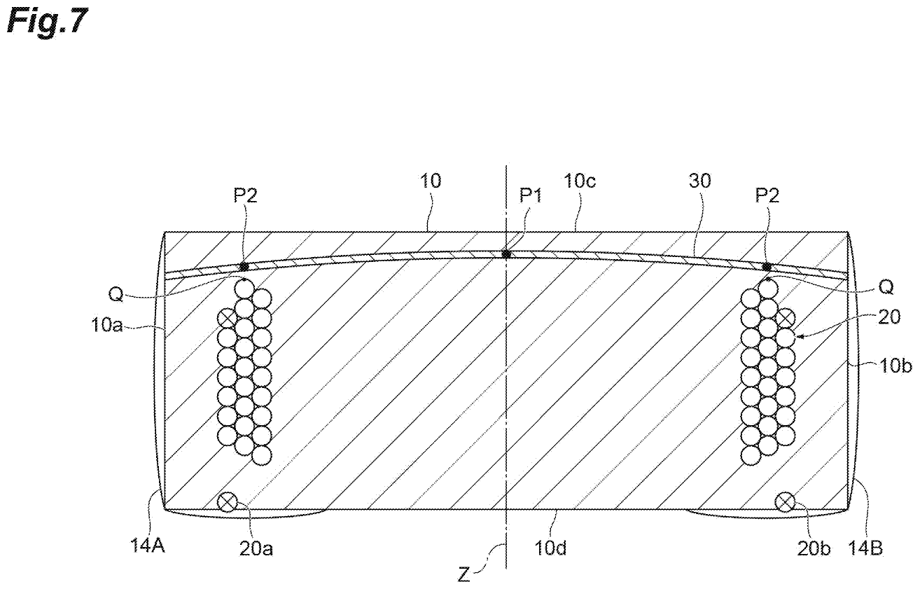

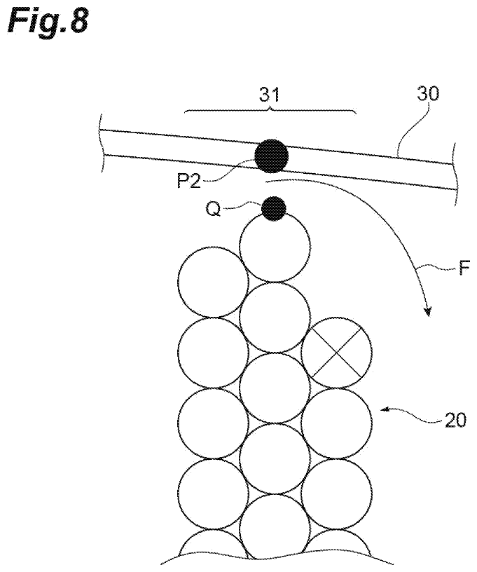

In the magnetic sheet 30 according to the second embodiment, as shown in FIG. 7, the magnetic sheet 30 is bent as a whole to be convex toward the upper surface 10c side of the element body 10. In particular, the magnetic sheet 30 is generally curved with respect to the direction of the axis Z of the coil 20 such that the position P1 corresponding to the axis Z of the coil 20 is in the highest position and progressively lower away from the position P1 corresponding to the axis Z of the coil 20. In the present embodiment, the magnetic sheet 30 has a line-symmetric cross-sectional shape with respect to the axis Z of the coil 20 in the cross-section shown in FIG. 7. The magnetic sheet 30 is uniformly inclined in the area 31 overlapping with the coil 20 in the vertical direction as shown in FIG. 8. That is, the magnetic sheet 30 is inclined such that the inner edge side of the coil 20 is higher and the outer edge side is lower. In particular, the magnetic sheet 30 is inclined such that portions of both the position P2 corresponding to the tip position Q on the end surface 10a side of the coil 20 and the position P2 corresponding to the tip position Q on the end surface 10b side of the coil 20 with respect to the direction of the axis Z of the coil 20 approach the lower side (i.e., the coil 20 side) as the portions separates from the axis Z of the coil 20. With respect to the direction of the axis Z of the coil 20, each of the positions P2 of the magnetic sheet 30 corresponding to the tip positions Q of the coil 20 on the end surfaces 10a and 10b side is positioned on the lower side (i.e., on the lower surface 10d side of the element body 10) with respect to the position P1.

The magnetic sheet 30 according to the second embodiment may have a cross-sectional shape that is not line-symmetric with respect to the axis Z of the coil 20 (i.e., asymmetric cross-sectional shape). In this case, the highest position of the magnetic sheet 30 may shift away from the position P1 corresponding to the axis Z of the coil 20 in the cross-section shown in FIG. 7. In the cross section shown in FIG. 7, the magnetic sheet 30 may have different positions in the vertical direction (i.e., different height positions) between the positions P2 corresponding to the tip positions Q of the coil 20 on the end surfaces 10a and 10b side, and may have different inclinations in the area 31 overlapping the coil 20 in the vertical direction.

In the coil component 1 according to the second embodiment, the magnetic sheet 30 is inclined in the area 31 overlapping with the coil 20 in the vertical direction, and the magnetic sheet 30 is along the orientation of the magnetic flux F in the vicinity of the outer edge of the coil 20, as shown in FIG. 8. Therefore, the magnetic flux F easily passes through the magnetic sheet 30, and reduction of leakage flux in the coil component 1 is realized.

Similar to the first embodiment, only one magnetic sheet 30 according to the second embodiment may be provided in the element body 10, or a plurality of the magnetic sheets 30 may be provided in the element body 10.

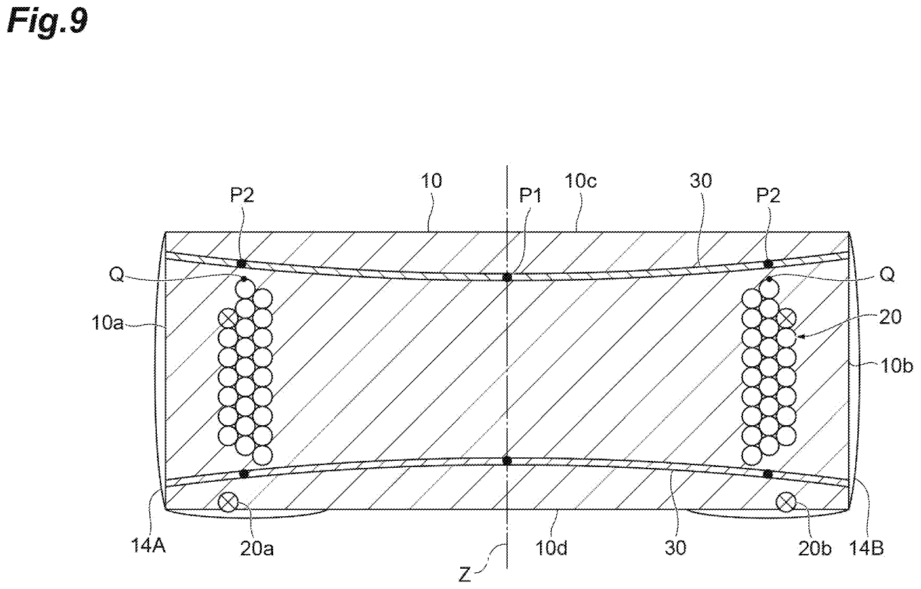

As shown in FIG. 9, a plurality of the magnetic sheet 30 may be positioned on the upper and lower sides of the coil 20. In this case, the coil 20 is positioned between layers of the magnetic sheets 30. Even in such a mode, the magnetic sheet 30 is inclined in the area 31 overlapping with the coil 20 in the vertical direction, and the direction of the magnetic flux F in the vicinity of the inner edge (or the vicinity of the outer edge) of the coil 20 is along the orientation of the magnetic sheets 30, thereby, the magnetic flux F easily passes through the magnetic sheet 30 and reduction of leakage flux in the coil component 1 can be realized.

The present disclosure is not necessarily limited to the above-described embodiments, and various modifications can be made without departing from the scope of the present disclosure. For example, the shape of the coil in plain view is not limited to elliptical annular or rectangular annular, and may be annular or polygonal annular.

What is claimed is:

1. A coil component comprising:
an element body made of material including metal powder and resin;
a coil provided in the element body; and
a magnetic sheet extending to intersect an axis of the coil in the element body;
wherein the magnetic sheet has a portion corresponding to a tip position of the coil with respect to a direction of an axis of the coil, and the portion is inclined toward the coil side as the portion approaches the axis of the coil.

2. A coil component comprising:
an element body made of material including metal powder and resin;
a coil provided in the element body; and
a magnetic sheet extending to intersect an axis of the coil in the element body;
wherein the magnetic sheet has a portion corresponding to a tip position of the coil with respect to a direction of the axis of the coil, and the portion is inclined toward the coil side as the portion separates from the axis of the coil.

3. A coil component comprising:
an element body made of material including metal powder and resin;
a coil provided in the element body; and
a magnetic sheet extending to intersect an axis of the coil in the element body;
wherein the magnetic sheet has a portion corresponding to a tip position of the coil with respect to a direction of the axis of the coil and a portion corresponding to the axis of the coil, the positions of the magnetic sheet with respect to the direction of the axis of the coil are different therebetween.

4. The coil component according to claim 1 comprising a plurality of layers of the magnetic sheets in the element body.

5. The coil component according to claim 4, wherein materials of the plurality of layers of magnetic sheets are different.

6. The coil component according to claim 4, wherein material of the element body is interposed between adjacent layers of the magnetic sheets.

7. The coil component according to claim 6, wherein amount of material of the element body interposed between adjacent layers of the magnetic sheet on an outer side of the coil is larger than that on an inner side of the coil with respect to a direction perpendicular the axis of the coil.

8. The coil component of claim 4, wherein the coil is positioned between the plurality of layers of the magnetic sheets.

9. The coil component according to claim 1, wherein the magnetic sheet has a multilayer structure.

10. The coil component according to claim 9, wherein materials of the plurality of layers of the magnetic sheets are different.

11. The coil component according to claim 1, wherein the magnetic sheet is formed of a metal plate.

12. The coil component according to claim 1, wherein the magnetic sheet extends over an entire region of the element body when viewed from a direction of the axis of the coil.

13. The coil component according to claim 1, wherein the coil is a coil around which a wire is wound.

14. The coil component according to claim 2 comprising a plurality of layers of the magnetic sheets in the element body.

15. The coil component according to claim 2, wherein the magnetic sheet has a multilayer structure.

16. The coil component according to claim 2, wherein the magnetic sheet is formed of a metal plate.

17. The coil component according to claim 3 comprising a plurality of layers of the magnetic sheets in the element body.

18. The coil component according to claim 3, wherein the magnetic sheet has a multilayer structure.

19. The coil component according to claim 3, wherein the magnetic sheet is formed of a metal plate.
